(19) United States
(12) Patent Application Publication
(10) Pub. No.: US 2015/0248438 A1
(43) Pub. Date: Sep. 3, 2015

(54) DEVICE AND METHOD FOR RECORDING THERMAL IMAGING INFORMATION

(71) Applicant: Hao WANG, (US)

(72) Inventor: Hao Wang, Hangzhou (CN)

(21) Appl. No.: 14/430,213

(22) PCT Filed: Sep. 20, 2013
(86) PCT No.: PCT/CN2013/083852

§ 371 Date: Mar. 21, 2015

(30) Foreign Application Priority Data
Sep. 21, 2012 (CN) 201210353453.3

(51) Int. Cl. G06F 17/30; H04W 4/02; H04N 5/232; H04N 5/33

(52) U.S. Cl. CPC G06F 17/30265; H04N 5/33; H04W 4/02; H04N 5/23293

(57) ABSTRACT

This invention provides a device and method for recording thermal imaging information, and relates to a thermal imaging device and an infrared detection filed. The position information (such as GPS information) record by a thermal imaging device in the prior art cannot conveniently correspond to object information. As only the GPS information is record, during subsequent arrangement, the object information needs to be correspondingly input according to the GPS information, causing the heavy workload. According to the device for recording thermal imaging information in this invention, the object information corresponding to the received position information is displayed according to the received position information, then the object information is selected, and the selected object information is record with the infrared data, thereby solving the present problem.

### BACKGROUND OF THE INVENTION

1. Field of the Invention

This invention relates to a thermal imaging device and an infrared detection field and, more particularly to a device and method for recording thermal imaging information.

2. Description of the Related Art

Thermal imaging devices are widely applied in different industries. At present, a filename of a thermal image file acquired by photographing is generated according to time or sequence numbers. For subsequent filing and analyses, it is necessary to distinguish thermal image files of different objects acquired by photographing. During infrared detection, a user needs to record object information according to cognition of the object or a local nameplate. The common record mode may include the following ways: a man may record a filename of a thermal image file and the corresponding object information on sheets of paper; a file folder corresponding to the object information may be built in a storage card, and a thermal image file may be put in the corresponding file folder; voice notes of the local object information are attached to the thermal image file. The above operation has trivial details, and the subsequent arranging workload is heavy. The use of a device for recording thermal imaging information with a position detecting device such as GPS may bring certain convenience. For example, during photographing of electric power lines, GPS information may be prompted, and the GPS information may be record with the thermal image file.

In the prior art, the record GPS information cannot conveniently correspond to object information. As only the GPS information is record, during the subsequent arrangement, the GPS information has to correspond to the object information, causing the heavy workload. Further, in most cases of infrared detection, a plurality of objects are located at the same position. For example, a 500KV tower may usually include a plurality of objects (parts) of different types, such as an electrical insulator, splicing sleeves of wires, and jointing clamps, and the different objects (parts) may be usually photographed singly in actual photographing. Thereby, the problem of recording the object information fails to be solved by only recording the position information, and a user still need to record the object information manually. How to conveniently record the thermal image file related to the object information is a problem.

Therefore, an infrared recording device is necessary, by which the user can conveniently record the object information associated with the thermal image file, thereby solving the present problem.

### BRIEF SUMMARY OF THE INVENTION

This invention provides a device and method for recording thermal imaging information. According to received position information, object information corresponding to the received position information is displayed in an infrared thermal image, then the object information is selected, and the selected object information is stored with the infrared data, thereby solving the present problem, reducing technical requirements of users, improving the photographing quality and speed, and reducing the work strength.

This invention provides a device for recording thermal imaging information including the following parts.

An acquiring part is used for acquiring thermal imaging data.

A position information acquiring part is used for acquiring position information.

A position comparing part is used for comparing the position information acquired by the position information acquiring part with prestored position information stored in a storage medium, to determine the prestored position information matching the acquired position information.

A selecting part is used for selecting object information, based on the object information related to the prestored position information in the storage medium, according to the prestored position information matching the acquired position information.

A record part is used for recording the object information selected by the selecting part associated with the specified infrared data. The infrared data is the thermal imaging data acquired by the acquiring part and/or data acquired after specified processing for the thermal imaging data acquired by the acquiring part.

Based on the above technical solution, this invention further provides a device further including the following parts.

An informing part is used for informing a matching result of the position comparing part.

In response to predetermined operation of a user, an information display controlling part is used for controlling a display part to display a specified quantity of object selecting information acquired by multiple object information, according to the prestored position information matching the acquired position information, based on the multiple object information related to the prestored position information stored in the storage medium. The selecting part is used for selecting the object information corresponding to the object selecting information selected by the user.

When there are a plurality of objects, the accuracy of the record object information and convenience of the operation can be ensured.

This invention provides a method for recording thermal imaging information including the following steps.

An acquiring step is used for acquiring thermal imaging data.

A position information acquiring step is used for acquiring position information.

A position comparing step is used for comparing the position information acquired in the position information acquiring step with prestored position information stored in a storage medium, to determine the prestored position information matching the acquired position information.

A selecting step is used for selecting object information according to the prestored position information matching the acquired position information, based on the object information related to the prestored position information stored in the storage medium.

A record step is used for recording the object information selected in the selecting step associated with the specified infrared data, and the infrared data is the thermal imaging data acquired in the acquiring step and/or data acquired after specified processing for the thermal imaging data acquired in the acquiring step.

These and other aspects and advantages of the present invention will be described in the following description.

### BRIEF DESCRIPTION OF THE DRAWINGS

FIG. 1 is a block diagram showing a device for recording thermal imaging information according to one embodiment of the invention;

FIG. 2 is an outline diagram showing a device for recording thermal imaging information according to one embodiment of the invention;

FIG. 3 is a schematic diagram showing object information and prestored position information in a storage medium;

FIG. 4 is a schematic diagram showing display interfaces as an object 1 and an object 2 are photographed, wherein a display interface 401 is a display interface when the position information matches the prestored position information 1, a display interface 402 is a display interface when a user determines that the position information matches the prestored position information 1, a display interface 403 is a display interface when the position information matches the prestored position information 2, a display interface 404 is a display interface when the user determines that the position information matches the prestored position information 2, and a display interface 405 is a display interface after the user selects the object 2;

FIG. 5 is a flow chart showing information mode processing according to one embodiment;

FIG. 6 is a schematic diagram showing a file data format of a thermal imaging file;

FIG. 7 is a block diagram showing a system for recording thermal imaging information including a thermal image processing device 100 and a thermal image photographing device 101;

FIG. 8 is a schematic diagram showing a system for recording thermal imaging information including a thermal image processing device 100, a thermal image photographing device 101, and a position detecting part 102 according to one embodiment.

### DETAILED DESCRIPTION OF THE INVENTION

The embodiments of the invention may be described with regard to the drawings. The embodiments described in the following are used for better understanding the invention without limiting the scope of the invention, and different forms in the invention may be changed in the scope. The called thermal imaging data may be thermal image AD data (such as data acquired after AD conversion for output signals of an infrared detector), image data of an infrared thermal image, array data of temperature values, or other data generated based on the thermal image AD data.

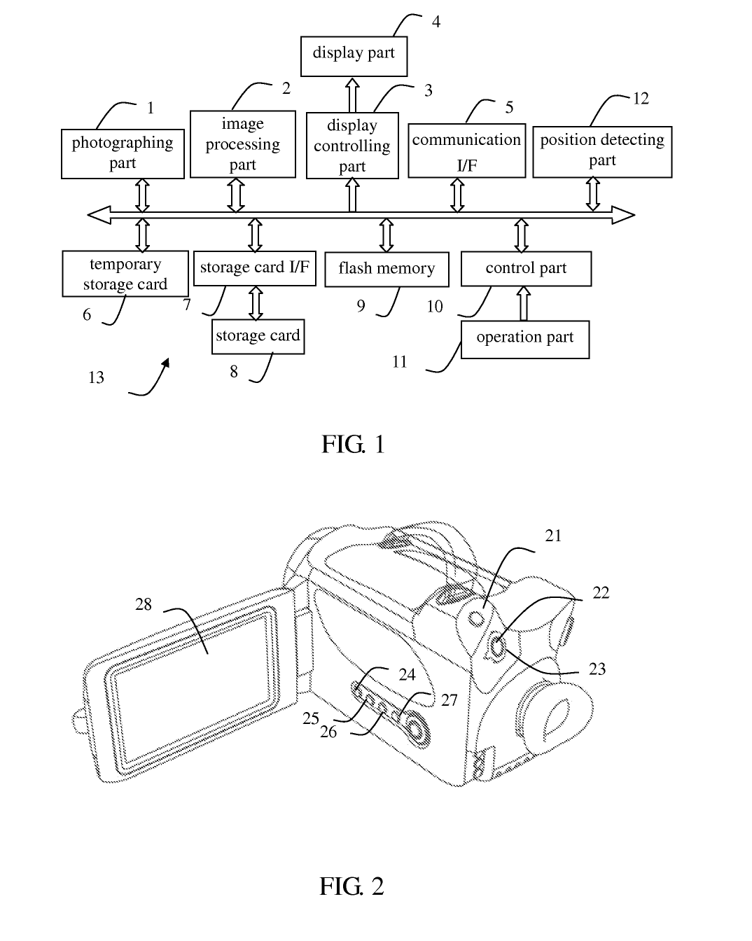

In the first embodiment, a thermal imaging device 13 is as an example of a device for recording thermal imaging information. The structure of the thermal imaging device 13 is described in reference to FIG. 1. FIG. 1 is a block diagram showing the thermal imaging device 13 according to the embodiment.

The thermal imaging device 13 includes a photographing part 1, an image processing part 2, a display controlling part 3, a display part 4, a communication I/F 5, a temporary storage part 6, a storage card I/F 7, a storage card 8, a flash memory 9, a control part 10, an operation part 11, and a position detecting part 12. The control part 10 is connected with the corresponding part via a control and data bus, and is responsible for overall control of the thermal imaging device 13.

The photographing part 1 includes an optical part, a lens driving part, an infrared detector, and a signal preprocessing circuit, which are not shown. The optical part is composed of infrared optical lenses, and is used for focusing received infrared radiation on the infrared detector. The lens driving part drives the lens to perform focusing or zooming operation according to a control signal of the control part 10, and the optical part may also be manually regulated. The infrared detector, such as a refrigerating or non-refrigerated infrared focal plane detector, converts the infrared radiation passing through the optical part to electrical signals. The signal preprocessing circuit includes a sample circuit, an AD conversion circuit, and a timing trigger circuit, and performs signal processing such as sampling for the signals output from the infrared detector in a specified period. The signals are converted to digital thermal imaging data by the AD conversion circuit. The thermal imaging data may be 14-bit or 16-bit binary data (also called AD value).

The image processing part 2 is used for performing specified processing for the thermal imaging data acquired by the photographing part 1. The image processing part 2 performs processing for converting data to be suitable for displaying or recording, such as modification, interpolation, pseudo-color, synthesis, compression, or decompression. The image processing part 2 is used for performing specified processing for the thermal imaging data acquired by the photographing part 1 to acquire image data of the infrared thermal image. For example, the image processing part 2 may perform the specified processing, such as non-uniformity correction or interpolation, for the thermal imaging data acquired by the photographing part 1, and performs the pseudo-color processing for the thermal imaging data after the specified processing to acquire the image data of the infrared thermal image. In one embodiment of the pseudo-color processing, a range of a corresponding pseudo-color plate may be determined according to a range of thermal imaging data (AD values) or a setting range of the AD values, and the particular color value to which the thermal imaging data corresponds in the range of the pseudo-color plate is used as the image data of the corresponding pixel position in the infrared thermal image. In the embodiment, gray scaling for the infrared image may be as a special example of the pseudo-color processing. Further, based on record instruction of the control part 10, the image processing part 2 is used for performing specified compression for the thermal imaging data to acquire the compressed thermal imaging data, and then the thermal imaging data is record to a record medium such as the storage card 8. In addition, based on the control of the control part 10, the image processing part 2 performs different processing related to image processing, such as increasing and decreasing pixels to change the dimension of the image data, or cutting of the image data. The image processing part 2 may be realized by a DSP, other microprocessors, or a programmable FPGA, or the image processing part 2 may also be integrally formed with the control part 10.

The display controlling part 3 allows the image data for displaying stored in the temporary storage part 6 to be displayed on the display part 4 based on control of the control part 10. For example, in a standby mode, the infrared thermal image generated by the thermal imaging data acquired by photographing may be displayed continuously. In a replay mode, the infrared thermal image read and expanded from the storage card 8 may be displayed. In addition, different kinds of setting information may also be displayed. In detail, the display controlling part 3 includes a VRAM, a VRAM control unit, and a signal generating unit, regularly reads image data, read from the temporary storage part 6 and stored in the VRAM on the control of the control part 10, from the VRAM to generate video signals which are output and displayed on the display part 4. In the thermal imaging device 13, the display part 4 is an example of the display part. However, the invention is not limited. The display part may also be other display devices connected with the thermal imaging device 13, when the thermal imaging device 13 does not include a display part in itself. Obviously, the display controlling part (the control part 10) may also control to output image data for displaying. For example, via an image output interface (such as different kinds of wired or wireless image output interfaces, i.e. an AV interface), the image data (such as the control part 10 or the display controlling part 3 as an example of the display controlling part) for displaying may be output. The display controlling part also controls the display output conditions. The display controlling part 3 may be integrally formed with the image processing part 2 or the control part 10.

The communication I/F 5 may be an interface for connecting the thermal imaging device 13 and an external device and for exchanging data according to communication specification such as USB, 1394, or network. The external device may be a personal computer, a server, a PDA (personal digital assistant device), other thermal imaging devices, a visible light photographing device, or a storage device.

The temporary storage part 6, such as a RAM or DRAM volatile storage, is a buffer storage for temporarily storing the thermal imaging data output from the photographing part 1, and is a working storage of the image processing part 2 and the control part 10 for temporarily storing the processed data of the image processing part 2 and the control part 10. However, the invention is not limited. The storage or register in a processor such as the control part 10 or the image processing part 2 may also be defined as a temporary storage medium.

The storage card I/F 7 is used as an interface of the storage card 8. The storage card I/F 7 is connected with the storage card 8 as a rewritable nonvolatile storage, which can be detachably installed in a groove of the main body of the thermal imaging device 13 and can record the data such as the thermal imaging data according to the control of the control part 10.

The flash memory 9 stores control programs and different data used in the control of each part.

The operation part 11 is used for a user to perform different instructing operation or different operation such as inputting setting information. The control part 10 performs corresponding programs according to operation signals of the operation part 11. Refer to FIG. 2, the operation part 11 is described. The keys provided for users include a record key 21, a focusing key 22, a menu key 23, a mode key 24, an enter key 25, a direction key 26, and a replay key 27. The record key 21 is used for performing record operation, the focusing key 22 is used for performing focusing operation, the menu key 23 is used for entering or exiting a menu mode, the mode key 24 is used for entering or exiting an information mode, the enter key 25 is used for determination, the direction key 26 is used for selecting menu items, and the replay key 27 is used for entering or exiting a replay mode. However, the invention is not limited thereto. The corresponding operation may be realized by a touch screen 28 or a phonic part (not shown).

The position detecting part 12 may be installed in the thermal imaging device 13, or may be an external receiving device connected with the thermal imaging device 13 wiredly or wirelessly. As the prior art, for example, a GPS receiving device with the global positioning function (such as GPS) may be installed in the thermal imaging device 13, or a GPS receiving device is connected with the thermal imaging device 13 externally, and the detected position information may represent a position of the thermal imaging device 13 or may be positions of objects (such as the position detecting part further includes a directional and laser ranging part, for acquiring position information of an object according to position information of a user). In addition, the position detecting part 12 may be a device for detecting directions or positions, such as Big Dipper or a radio-frequency emitting device.

The whole action of the thermal imaging device 13 is controlled by the control part 10, and the flash memory 9 stores control programs and different data used in control of each part. The thermal imaging device 13 includes the following parts in function.

A photographing part is used for acquiring thermal imaging data.

A position information acquiring part is used for acquiring position information.

A position comparing part is used for comparing the position information acquired by the position information acquiring part with prestored position information stored in a storage medium in advance, to determine the prestored position information matching the acquired position information.

A selecting part is used for selecting the object information according to the prestored position information matching the acquired position information, based on the object information related to the prestored position information stored in the storage medium.

A record part is used for recording the object information selected by the selecting part associated with the specified infrared data. The infrared data is the thermal imaging data acquired by the photographing part and/or data acquired after specified processing for the thermal imaging data acquired by the photographing part.

In the embodiment, the storage medium may be a storage medium in the thermal imaging device 13, such as a non-volatile storage medium i.e. the flash memory 9 or the storage card 8 or a volatile storage medium i.e. the temporary storage part 6, or may be other storage mediums connected with the thermal imaging device 13 wiredly or wirelessly, such as other devices connected with the communication I/F 5 wiredly or wirelessly, i.e. other storage devices, storage mediums in a thermal imaging device or a computer, or storage mediums of a network destination. Preferably, the object information related to the object and the prestored position information may be prestored in the thermal imaging device 13 or a non-volatile storage medium connected with the thermal imaging device 13. In the embodiment, the flash memory 9 is as an example of the storage medium for storing the prestored position information.

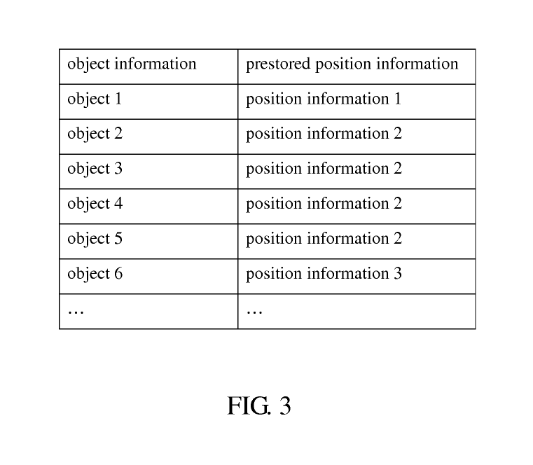

Refer to a table in FIG. 3 (called Table 3 hereinbelow), the prestored position information and the object information stored in the storage medium is described. In Table 3, the multiple prestored position information and multiple object information is associated via Table 3.

The prestored position information may relate to one or more object information. For example, in Table 3, the prestored position information “position information 1” is related to the object information “object 1”, while the prestored position information “position information 2” is related to the object information “object 2, object 3, object 4, object 5”. The prestored position information stored in the storage medium may be directed to the position information of the object, and further may be directed to the position information of the photographing position of the thermal imaging device 13.

The object information is the information related to the objects, such as the information representing a position, a type, and a number of an object or a combination thereof. For example, the object information “object 1” may represent the object “route 1 tower 1 equipment 1 phase A”. In addition, different kinds of information, such as an attribution unit, a classified grade (such as a voltage grade or an importance grade), a model, a manufacturer, performance and characteristics, a passed photographing or repairing record, a manufacturing data, a service life, or parts, related to an object, may be taken for example.

The object selecting information may be acquired by an information display controlling part according to the prestored position information matching the acquired position information, based on the object information related to the prestored position information stored in the storage medium, and may be part or whole of the object information.

The information display controlling part controls the display part to display the object instructing information acquired by the selected object information according to the object information selected by the selecting part, and the object instructing information may be part or whole of the object information.

The object selecting information may be the same with the object instructing information. Preferably, the content of the object instructing information is more than that of the object selecting information.

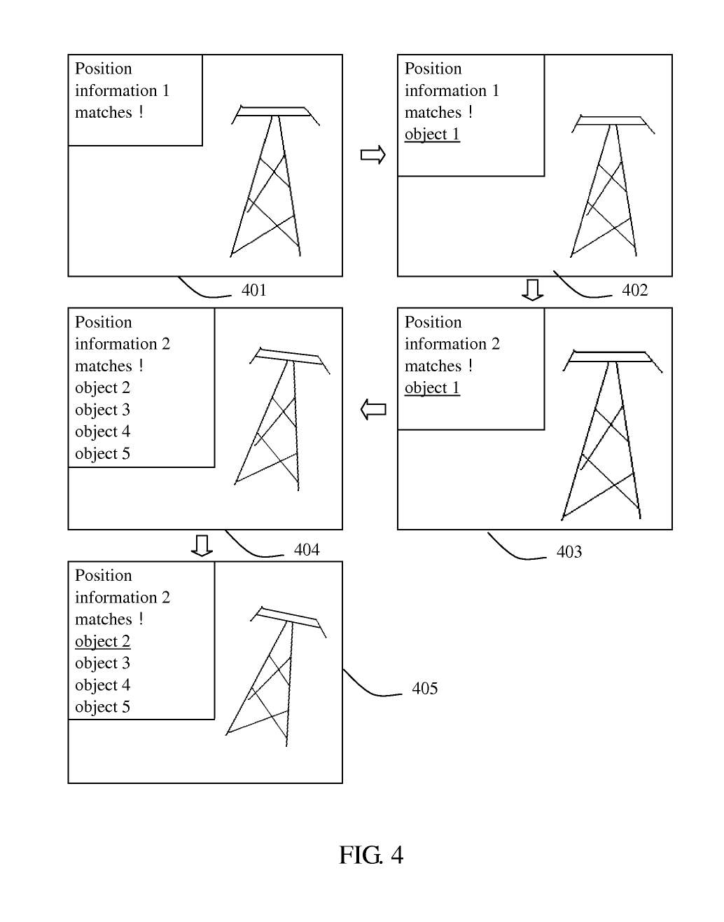

FIG. 4 is a schematic diagram showing display interfaces as the object 1 and object 2 are photographed.

A display interface 401 is a display interface when the position information matches the prestored position information 1.

A display interface 402 is a display interface when a user determines that the position information matches the prestored position information 1.

A display interface 403 is a display interface when the detected position information matches the prestored position information 2, and the instructing information of the object 1 is still displayed.

A display interface 404 is a display interface when the user determines that the detected position information matches the prestored position information 2, and the instructing information of the object 2 to the object 5 is displayed at that moment.

A display interface 405 is a display interface after the user selects the object 2.

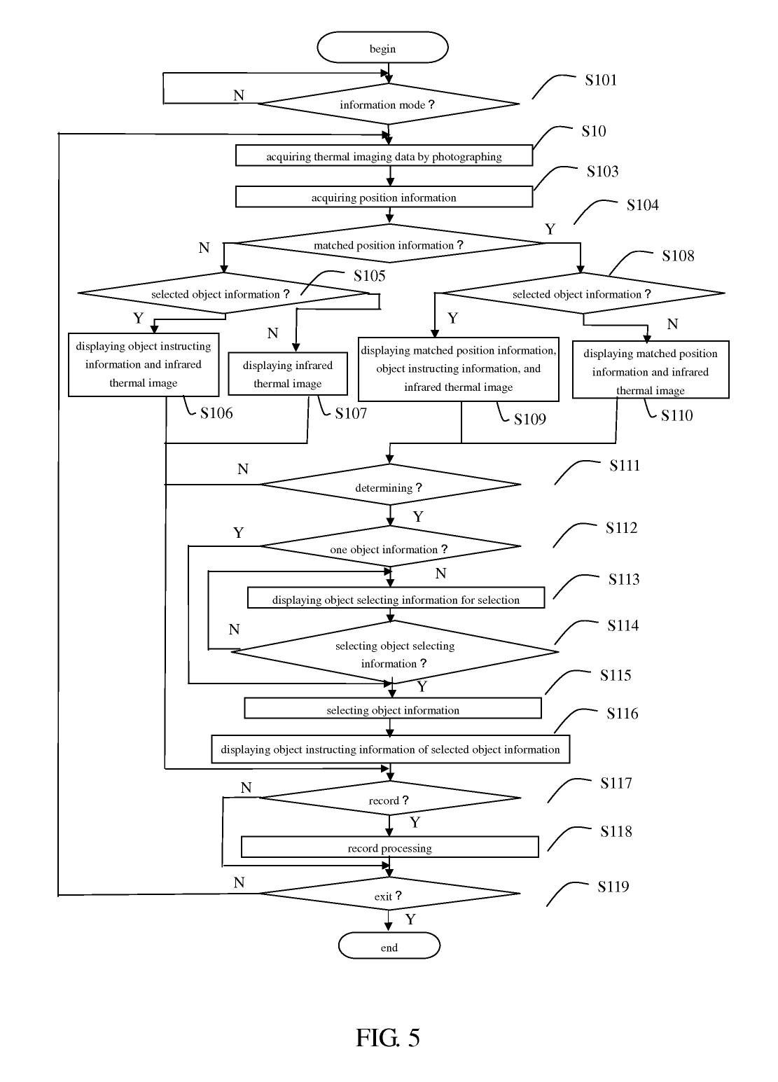

According to the flow chart in FIG. 5, the control steps of the information mode in the first embodiment are described.

The detailed operation and control flow of the first embodiment are described in detail hereinbelow. Before photographing formally, the flash memory 9 stores Table 3 in FIG. 3 in advance. The control part 10 controls the whole action of the thermal imaging device 13 and multiple mode processing based on the control programs stored in the flash memory 9 and different data used in control of each part. When the power is on, the control part 10 initializes interior circuits. Then, a standby mode is entered. That is, the photographing part 1 acquires the thermal imaging data, the image processing part 2 performs specified processing for the thermal imaging data acquired by the photographing part 1, the processed data is stored in the temporary storage part 6, and the control part 10 controls the display controlling part 3 to allow the display part 4 to continuously display the infrared thermal image in a dynamic mode. In this state, the control part 10 continuously monitors if other modes are switched according to predetermined operation or shutdown operation is performed. If yes, corresponding processing is entered.

In step S101, the control part 10 continuously monitors if a user selects an information mode. When the user presses the mode key 24, the information mode is entered.

In step S102, the photographing part 1 acquires the thermal imaging data, the image processing part 2 performs specified processing for the thermal imaging data acquired by the photographing part 1, and the processed data is stored in the temporary storage part 6.

In step S103, the control part 10 as the position information acquiring part controls to allow the GPS position information received by the position detecting part 12 (such as a GPS receiving device) to be stored in the temporary storage part 6. The GPS receiving device receives the GPS information according to a specified frequency (such as every other second). The GPS position information may be the longitude, latitude, and direction when the GPS device receives data from three satellites, and the GPS position information may be the longitude, latitude, altitude, and direction when the GPS device receives data from four satellites. The received GPS position information may be displayed on the display part 4.

In step S104, then the control part 10 as the position comparing part compares the received GPS position information (the acquired position information) with the prestored position information in Table 3, to determine whether there is the prestored position information matching the acquired position information (in accord with a specified error range). If there is no matched prestored position information, the next step is performed. If there is matched prestored position information, step S108 is performed.

In step S105, whether there is the selected object information is determined. For example, whether there is the selected object information in a specified area of the temporary storage part 6 may be determined. If yes, in step S106, the object instructing information and infrared thermal image is displayed. If no, in step S107, the infrared thermal image is displayed.

In the step S108, whether there is the selected object information is determined. For example, whether there is the selected object information in the specified area of the temporary storage part 6 may be determined. If yes, in step S109, the matched informing instruction, the object instructing information, and the infrared thermal image is displayed, as shown in 403 in FIG. 4. If no, in step S110, the matched informing instruction and the infrared thermal image is displayed, as shown in 401 in FIG. 4.

The informing processing is to inform of the determined matched prestored position information (or the GPS position information). The control part 10 as the informing part controls the display part 4 to blinkingly display the position information or to further display the object information to which the prestored position information acquired according to the object information stored in the flash memory 9 corresponds. As shown in the display interface 401 in FIG. 4, the display part 4 may display the matched GPS position information or the prestored position information, or may together display the object information related to the prestored position information. In addition, there are different kinds of informing ways, such as displaying changes of letters or images (including infrared thermal images) in the display part, light emitted by guiding lamps, voice prompt, or vibration, as long as the perceptual ways of the user. In addition, if the object information is selected before, and the matched position information is detected during photographing, the position information is displayed, facilitating the user to prepare and determine, as shown in the display interface 403 in FIG. 4.

In step S111, the control part 10 determines whether the user performs determination via the enter key 28. If no, the step S117 is performed. If yes, the next step is performed.

In step S112, whether the matched prestored position information is related to one piece of object information or multiple object information is detected. If only one is related, the step S115 is performed. For example, if the matched prestored position information is “position information 1”, which is only related to the object information “object 1”, the control part 10 may automatically select the object information in the step S115. Then, in step S116, the control part 10 acquires the object instructing information according to the selected object information, and the acquired object instructing information is stored in a specified area of the temporary storage part and is displayed on the display part 4 as shown in the display interface 402. If the multiple object information is related, the next step is performed.

In step S113, the control part 10 allows the display part 4 to display a specified amount of the object selecting information acquired according to the object information related to the matched prestored position information at a specified place, based on Table 3 stored in the flash memory 9. For example, when the matched prestored position information is “position information 2”, such as the state as shown in the display interface 403, and when the user determines, the “object 2 to object 5” may be shown in the display interface 404.

In step S114, then, according to cognition of the object 2 on the scene, such as the equipment signboard, the object selecting information (such as corresponding to object 2 to object 5) displayed on the display part 4 is selected via the operation part 11. When selection is performed, step S115 is performed. The selecting part (the control part 10) selects the object information corresponding to the object selecting information selected by the user. Then, in step S116, the control part 10 acquires the object instructing information according to the selected object information, and allows the object instructing information to be stored in a specified area of the temporary storage part and to be displayed on the display part, such as “object 2” in the display interface 405 in FIG. 4. The special display is to only display the object instructing information acquired according to the selected object information or to display the object selecting information acquired according to a specified amount of the object information. The object instructing information acquired according to the selected object information is displayed in a way different that of other object selecting information.

In addition, when the object information in Table 3 is composed of attribute information of multiple attributes, the attribute information of the attributes composing the object information may be displayed in a list (or displayed in a tree view), and the object information is finally selected after multiple selections. For example, supposing that “object 2” is composed of attribute information “route 1”, “tower 2”, “equipment 1” corresponding to the route attribute, the tower attribute, and the equipment type attribute, the “route 1” may be selected from the specified amount of the object selecting information (attribute information) to which the displayed route attribute corresponds, then the “tower 2” may be selected from the specified amount of the object selecting information (attribute information) to which the tower attribute corresponds, then the “equipment 1” may be selected from the specified amount of the object selecting information (attribute information) to which the equipment type attribute corresponds, and finally “object 2” may be selected. The selecting operation may be divided into multiple selections of the attribute information, to finally select the object information.

In step S117, the control part 10 determines whether there is record instructing operation. When a user presses the record key 21 of the operation part 11, the next step is performed.

In step S118, record processing is performed.

A record part is used for recording the object information selected by the selecting part associated with the specified infrared data, and the infrared data is the thermal imaging data acquired by the photographing part and/or data acquired after specified processing for the thermal imaging data acquired by the photographing part.

The control part 10 as the record part makes an associated record of the specified infrared data and the specified record information in response to record instructing operation or according to a specified record condition. Then the next step is performed.

The infrared data is the thermal imaging data acquired by the photographing part and/or data after specified processing for the thermal imaging data acquired by the photographing part. The specified infrared data may be the thermal imaging data (frame) acquired according to signals read by an infrared detector in response to the record instructing operation or when the time (or the later specified time) that the specified record condition is determined, the specified thermal imaging data (frame) in the multi-frame thermal imaging data temporarily stored in the temporary storage part 6 in response to the record instructing operation or when the time (or the later specified time) that the specified record condition is determined, the data after specified processing for the above thermal imaging data (the specified processing may be modification, interpolation, pseudo-color, temperature value conversion, pixel reduction, compression, or a combination thereof), the continuously record thermal imaging data, a record specified amount of multi-frame thermal imaging data, the thermal imaging data (frame) acquired after specified processing for the specified amount of the multi-frame thermal imaging data, such as one frame of the thermal imaging data acquired after integrating the multi-frame thermal imaging data stored in the temporary storage part 6, or a combination of the infrared data acquired above. For example, the infrared data may include temperature values of each pixel acquired by the thermal imaging data and image data of the infrared thermal image.

The specified record information may be the selected object information or the selected object information and the matched position information. The matched position information may be the matched prestored position information and/or the matched acquired position information, and the selected object information at least includes specified part or all of the selected object information.

In detail, in one embodiment, in response to the record instructing operation of the operation part 11, the control part 10 controls the infrared detector to read signals to acquire the thermal imaging data, allows the image processing part 2 to compress the thermal imaging data or to compress after specified processing for the thermal imaging data, such as modification or interpolation, and then determines whether the temporary storage part stores the specified record information at the specified area. If yes, the specified record information stored at the specified area of the temporary storage part 6 is associated with the compressed thermal imaging data, to generate a thermal image file record in the storage card 8, and the processing is end. In addition, the compression may be performed after the specified record information is attached. If no, the thermal image file generated by the compressed thermal imaging data is record to the storage card 8.

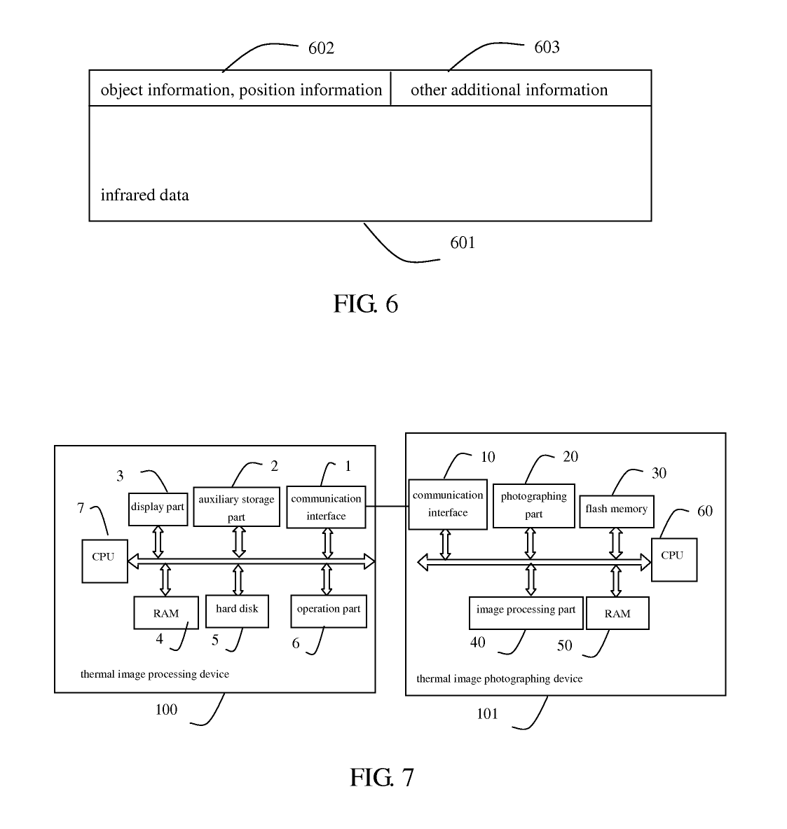

In one embodiment of associated record, the specified record information is as information attachment of the infrared data with the specified format, as a schematic diagram showing a structure of a thermal image file shown in FIG. 6. The infrared data 601 is the thermal imaging data in response to the record instructing operation or acquired by reading from the infrared detector at the time of a specified record condition or the processed data, the specified record information 602 may be object information or matched position information, and the other attached information 603 may be photographing time.

The display interface 401 to 405 in FIG. 4 is taken for example, thus to describe the associated record specified record information in the above states.

The specified record information in the state of the display interface 401 includes the position information 1 and/or the acquired matched position information.

The specified record information in the state of the display interface 402 includes the object 1 or further includes the position information 1.

The specified record information in the state of the display interface 403 includes the object 1 or further includes the position information 1.

The specified record information in the state of the display interface 404 includes the position information 2 and/or the acquired matched position information.

The specified record information in the state of the display interface 405 includes the object 2 or further includes the position information 2.

In step S119, the control part 10 determines whether the user exits from the reference mode. If no, return to the step S102, the position information is continuously acquired, and the instructing information acquired by the selected object information is displayed at the same time. Further, the user can record for a plurality of times. If there is exiting instruction, the reference mode is end.

In addition, the storage medium for record is not limited to the storage card 8 or the flash memory 9, and may be network destination communicated via the communication I/F 5.

In addition, during the associated record, the specified record information may be record in an information file or an index file associated with the thermal image file. The control part 10 may generate the information file or the index file.

In addition, a file name of a thermal image file may be generated according to the object information. The record part includes a file-name generating unit for generating the file name of the thermal image file. The file name at least includes the information related to the designated special object information. For example, the generated file name of the thermal image file is object 1.jpg. Further, the time information “20120223” is combined to generate the file name, such as object 1-20120223.jpg. The substance of associated record is to record the information facilitating the subsequent batch processing, and the file name includes the object information, which facilitates the user to examine.

The substance of the associated record is to record the information facilitating the subsequent batch processing. For example, the object information and the prestored position information may be record for subsequently classifying the infrared data, thereby facilitating the subsequent batch processing. The above embodiment can solve the deficiency in the prior art.

### Embodiment Two

Although the first embodiment is applied to the thermal imaging device 13 with the photographing function, this invention is not necessary for acquiring the thermal imaging data via photographing. This invention may be applied to a thermal image processing device receiving and processing the thermal imaging data (thermal image transferring data) externally. The thermal image transferring data may be thermal image AD data, infrared images generated by the thermal imaging data, the compressed thermal imaging data, or data of the compressed infrared thermal image. A thermal image processing device 100 is as an example of the device for recording thermal imaging information.

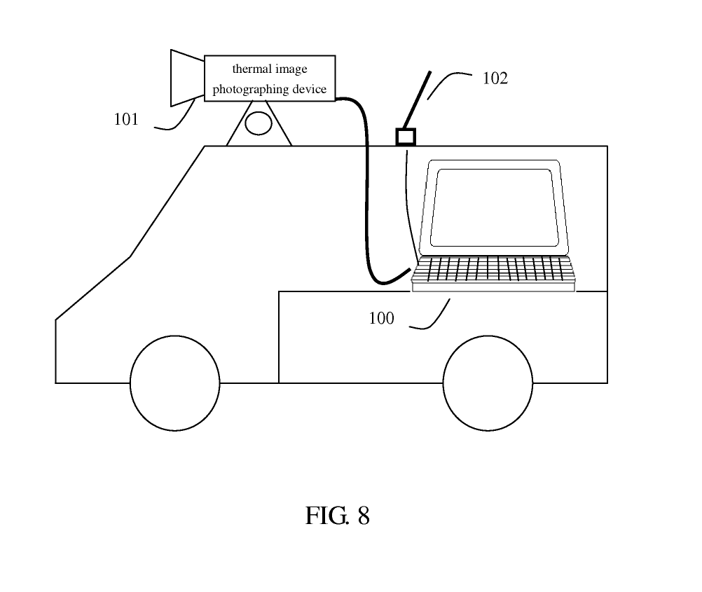

FIG. 7 is a block diagram showing a thermal image processing system including a thermal image processing device 100 and a thermal image photographing device 101 connected with each other.

The thermal image processing device 100 includes a communication interface 1, an auxiliary storage part 2, a display part 3, a RAM 4, a hard disk 5, an operation part 6, and a CPU 7 connected with the above parts via a bus and performing overall control. The thermal image processing device 100 may be a personal computer, a personal digital assistant, or a display device used with the thermal image photographing device in a set. The thermal image processing device 100 receives the thermal image transferring data output by the thermal image photographing device 101 connected with the thermal image processing device 100 via the communication interface 1 based on the control of the CPU 7.

The communication interface 1 is used for continuously receiving the thermal image transferring data output by the thermal image photographing device 101, such as the thermal image transferring data transferred via a relay device (the thermal image transferring data output by the thermal image photographing device 101 is transferred via the relay device), and is also used a communication interface for controlling the thermal image photographing device 101 and for connecting the position detecting part 102 (not shown). In the embodiment, the communication interface includes different kinds of wired or wireless communication interfaces on the thermal image processing device 100, such as a network interface, a USB interface, a 1394 interface, or a video interface.

The auxiliary storage part 2 may be a storage medium, such as a CD-ROM or a storage card, or a related interface.

The display part 3 may be a liquid display, and the display part 3 may further be other display connected with the thermal image processing device 100, while the thermal image processing device 100 does not include a display in itself.

The RAM 4 is used as a buffer storage for temporarily storing the thermal image transferring data received via the communication interface 1, and is also used as a working storage of the CPU 7 for temporarily storing the data processed by the CPU 7.

The hard disk 5 stores control programs and different data used in control.

The structure of the thermal image device 13 without the photographing part 1 is the same as that of the thermal image processing device 100. The acquired thermal image transferring data is also suitable to this embodiment. Therefore, the description in the embodiment is omitted.

The CPU 7 further performs the function of the image processing part, and is used for performing specified processing for the received thermal image transferring data to acquire image data of the infrared thermal image. The specified processing may be processing for converting data to be suitable for displaying or recording, such as modification, interpolation, pseudo-color, synthesis, compression, or decompression. There are different embodiments of the CPU 7 according different formats of the thermal image transferring data. In one embodiment, for example, when the received thermal image transferring data is the compressed thermal imaging data, the specified processing may be that the CPU 7 decompresses the thermal image transferring data received by the acquiring part and performs corresponding specified processing. In one embodiment, the specified processing after decompressing the thermal imaging data (the thermal image transferring data) is pseudo-color to acquire the image data of the infrared thermal image. In addition, the specified processing may be different specified processing such as correction or interpolation for the decompressed thermal image transferred data. In another embodiment, for example, when the received thermal image transferring data already is compressed image data of the infrared thermal image, the image data of the infrared thermal image is acquired via decompression. In another embodiment, when the communication interface 1 receives the analogic infrared thermal image, the image data of the digital infrared thermal image acquired after AD conversion via related AD converting circuit is transferred to the temporary storage part 6.

The thermal image photographing device 101 may be different kinds of thermal image photographing devices, and is used for photographing the object and outputting the thermal image transferring data. As shown in FIG. 7, the thermal image photographing device 101 includes a communication interface 10, a photographing part 20, a flash memory 30, an image processing part 40, a RAM 50, and a CPU 60. The CPU 60 controls the whole action of the thermal image photographing device 101, and the flash memory 30 stores control programs and different data used in each control. The photographing part 20 includes an optical part, a driving part, a thermal image sensor, and a signal preprocessing circuit, which are not shown, and is used for acquiring the thermal imaging data via photographing. The thermal imaging data is temporarily stored in the RAM 50, and then is processed by the image processing part 40 (such as DSP) to acquire the thermal image transferring data output via the communication interface 10. According to difference of designs and using aims, for example, the thermal imaging data output by the thermal image photographing device 101 may be the thermal imaging data after specified processing, the image data (the image data of the thermal image generated by the thermal imaging data) of the thermal image, the data acquired after compressing the thermal imaging data or the image data of the thermal image in a specified format, or a combination thereof, which are called thermal image transferring data in a joint name. In the embodiment, the thermal image photographing device 101 is used for photographing and outputting the thermal image transferring data, which is similar to the photographing part 1 of the thermal imaging device 13.

FIG. 8 is a schematic diagram showing a thermal image processing system including a thermal image processing device 100 and a thermal image photographing device 101. The position detecting part 102 (such as a device for detecting directions or positions i.e. GPS) is connected with the thermal image processing device 100.

The thermal image photographing device 101 is erect on a detection vehicle via an extension ladder, and is connected with the thermal image processing device 100 via communication wires such as special-use cables, or a local area network consisted in a wired or wireless mode. The users can watch and monitor the thermal image of the object via the thermal image processing device 100. The thermal image photographing device 101 is connected with the thermal image processing device 100 to form an information recording system in the embodiment, for acquiring the thermal imaging data by photographing the object and outputting the thermal image transferring data.

In addition, the processing and control function of part or all elements in the embodiments of the invention may be realized via special-use circuits, general processors, or programmable FPGA.

In addition, the objects in the power industry are taken as a scene for example, and different industry of the infrared detection is also suitable.

The above description is just embodiments of the invention, and the disclosure is not for limiting the scope of the invention. Persons having ordinary skill in the art may make various modifications and changes after reading the description, without departing from the scope and spirit of the invention.

1-10. (canceled)

11. A device for recording thermal imaging information, comprising:
an acquiring part for acquiring thermal imaging data;
a position information acquiring part for acquiring position information;
a position comparing part for comparing the position information acquired by the position information acquiring part with prestored position information stored in a storage medium, to determine the prestored position information matching the acquired position information;
a selecting part for selecting object information based on the object information related to the prestored position information stored in the storage medium according to the presorted position information matching the acquired position information;
a record part for recording the selected object information associated with specified infrared data, the infrared data being the thermal imaging data acquired by the acquiring part and/or data acquired after specified processing for the thermal imaging data acquired by the acquiring part.

12. The device for recording thermal imaging information according to claim 11, further comprising:
an informing part for informing a matching result of the position comparing part;
an information display controlling part, according to the prestored position information matching the acquired position information, based on the multiple object information related to the prestored position information stored in the storage medium, for controlling a display part to display a specified amount of object selecting information acquired by the multiple object information;
the selecting part for selecting the object information to which the object selecting information selected by a user corresponds.

13. The device for recording thermal imaging information according to claim 11, further comprising:
an informing part for informing a matching result of the position comparing part;
the selecting part for selecting the object information, in response to predetermined operation of a user, according to the prestored position information matching the acquired position information, based on the object information related to the prestored position information stored in the storage medium.

14. The device for recording thermal imaging information according to claim 12, wherein in response to predetermined operation of the user, according to the prestored position information matching the acquired position information, based on the multiple object information related to the prestored position information stored in the storage medium, the information display controlling part is used for controlling the display part to display a specified amount of the object selecting information acquired by the multiple object information.

15. The device for recording thermal imaging information according to claim 12, further comprising:
an instructing information display controlling part for controlling the display part to specially display the object instructing information and an infrared thermal image acquired by the selected object information according to the object information selected by the selecting part.

16. The device for recording thermal imaging information according to claim 12, wherein the user selects the object selecting information via a touch screen.

17. The device for recording thermal imaging information according to claim 11, wherein the record part comprises a file-name generating unit, and a file name of a generated thermal image file at least includes the object information selected by the selecting part.

18. The device for recording thermal imaging information according to claim 11, wherein the device for recording thermal imaging information is a portable thermal imager, and the acquiring part is used for continuously acquiring the thermal imaging data.

19. The device for recording thermal imaging information according to claim 18, wherein the position information acquired by the position information acquiring part is the position information acquired at a photographing position of the device for recording thermal imaging information.

20. A device for recording thermal imaging information, comprising:
an acquiring part for acquiring thermal imaging data;
a position information acquiring part for acquiring position information;
a position comparing part for comparing the position information acquired by the position information acquiring part with prestored position information stored in a storage medium, to determine the prestored position information matching the acquired position information;
an information display controlling part, according to the prestored position information matching the acquired position information, based on the multiple object information related to the prestored position information stored in the storage medium, for controlling a display part to display a specified amount of object selecting information acquired by the multiple object information;
a selecting part for selecting the object information to which the object selecting information selected by a user corresponds.

21. The device for recording thermal imaging information according to claim 20, further comprising:
a record part for recording the selected object information selected by the selecting part associated with specified infrared data, the infrared data being the thermal imaging data acquired by the acquiring part and/or data acquired after specified processing for the thermal imaging data acquired by the acquiring part.

22. The device for recording thermal imaging information according to claim 11, wherein the position information at least comprises GPS information.

23. A method for recording thermal imaging information, comprising:
an acquiring step for acquiring thermal imaging data;
a position information acquiring step for acquiring position information;
a position comparing step for comparing the position information acquired in the position information acquiring step with prestored position information stored in a storage medium, to determine the prestored position information matching the acquired position information;
a selecting step for selecting object information, according to the prestored position information matching the acquired position information, based on the object information related to the prestored position information in the storage medium;
a record step for recording the object information selected in the selecting step associated with specified infrared data, the infrared data being the thermal imaging data acquired in the acquiring step and/or data acquired after specified processing for the thermal imaging data acquired in the acquiring step.

24. A method for recording thermal imaging information, comprising:
an acquiring step for acquiring thermal imaging data;
a position information acquiring step for acquiring position information;
a position comparing step for comparing the position information acquired in the position information acquiring step with prestored position information stored in a storage medium, to determine the prestored position information matching the acquired position information;
an information display controlling step, according to the prestored position information matching the acquired position information, based on the multiple object information related to the prestored position information stored in the storage medium, for controlling to display a specified amount of object selecting information acquired by the multiple object information in a display step;
a selecting step for selecting the object information to which the object selecting information selected by a user corresponds.

25. The method for recording thermal imaging information according to claim 24, further comprising:
a record step for recording the selected object information in the selecting step associated with specified infrared data, the infrared data being the thermal imaging data acquired in the acquiring step and/or data acquired after specified processing for the thermal imaging data acquired in the acquiring step.
